(19) United States
(12) Patent Application Publication
(10) Pub. No.: US 2007/0165186 A1
(43) Pub. Date: Jul. 19, 2007

(54) Light source system and an image projection system

(76) Inventors: Nigel Joseph Copner, Gwent (GB); Allan Evans, Oxford (GB)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/331,592

(22) Filed: Jan. 13, 2006

(51) Int. Cl. G03B 21/26

(52) U.S. Cl. 353/30

(57) ABSTRACT

A light source system comprises a light source disposed within a non-imaging optical element. The non-imaging optical element does not produce a direct image of the light source, and the output light field at the output surface of the non-imaging optical element has an intensity that is substantially uniform over the area of the output surface. A light source system of the invention is therefore smaller and lighter than a prior art system of the same output power, since there is no need to provide further components, such as an integrator, to homogenise the output light field.

### FIELD OF THE INVENTION

This invention relates to a light source system, for example for use in an image projection system, and particularly to a light source system with improved brightness and colour balance. It also relates to an image projection system.

### BACKGROUND OF THE INVENTION

Image projection systems have been used for many years to project motion and still pictures onto screens for viewing. Presentations using multimedia projection systems are widely used to deliver information in diverse fields, such as sales, demonstrations, business meetings and education.

Many types of projection systems use non-emitting spatial light modulators in combination with an illumination source to generate an image. Colour image projection displays operate on the principle that colour images are produced from 3 primary colours, red (R), green (G) and blue (B), projected onto a screen, either at the same time or sequentially in time. The light of wavelength bands corresponding to these primary colours is generally separated from the broad band illumination emitted from the illumination source by using optical filters. The light separated from the broad band illumination is then modulated by one or more spatial light modulators, such as liquid crystal displays (LCDs) or digital micromirror devices (DMDs).

Viewers evaluate display systems based on many criteria: image size, resolution, contrast ratio, colour purity, intensity uniformity and brightness. Image brightness is a particularly important metric in many display markets since the available brightness can limit the image size of a projected image and it controls how well the image can be seen in venues having high level of ambient light. For a given projection engine architecture, the light source can be identified as one of the main factors that determine the brightness and colour reproduction of the projected image.

A schematic design of a typical electronic projector is shown in FIG. 13. Light from a discharge lamp 1 is focussed by the lamp's reflector 2 into an integrator rod 3. At the input face 3a of the integrator rod, the intensity of light is strongly peaked in the centre of the input face. Light propagates along the integrator rod, and multiple reflections in the rod homogenise the light beam so that, at the output face 3b, the intensity is almost uniform over the area of the output face. Collection optics, indicated generally at 5, image the light leaving the integrator with this uniform intensity profile onto a light modulator indicated generally at 6, which directs the light either through a projection lens 7 (for bright pixels) or onto a beam dump 8 (for dark pixels). A wavelength selector 4, here shown as a colour wheel as an example, may be placed in the light path to enable light of one primary colour to be selected.

A strong disadvantage of this design is the coupling losses between the various components in the system. For instance, more than 50% of the light emitted by the discharge lamp 1 is typically lost in coupling from the discharge lamp 1 into the integrator rod 3.

Image projection systems typically employ a high-intensity ultra-high pressure mercury lamp (UHP lamp), that provides a high luminous efficiency in the visible region of the spectrum. FIG. 1 shows a typical emission spectrum of a UHP lamp. As shown in this figure, a sufficient light intensity can be ensured in the blue and green spectral regions. However, the light intensity is insufficient in the red wavelength region of the spectrum above 600 nmn and this is known as a “red deficiency”. For this reason, in projectors employing a UHP lamp, the light intensity in the blue and green wavelength spectral regions is reduced in order to adjust the balance with the light intensity in the red wavelength spectral region and so ensure adequate colour reproduction. However, if the light intensity in the blue and green wavelength regions is reduced to provide light intensity balance with the light intensity in the red wavelength region, by for example, dimming the G and B channels or increasing the angular size of the red segment of a colour wheel, part of the illumination from the lamp is wasted.

As one method of solving the problem of colour imbalance, the light source may be a xenon lamp that has an emission spectrum with better intensity uniformity than that of a UHP lamp. However, the luminous efficiency of a xenon lamp is lower than that of a UHP lamp. Thus, the power consumption of a xenon lamp is markedly higher than that of a UHP lamp of equivalent brightness, and this is a disadvantage in many applications.

Another known method of improving the colour balance of a projection system by reducing the intensity imbalance between the red spectral region and the green and blue spectral regions is to combine a UHP lamp with an additional light source having a high output intensity of illumination in the regions where the UHP lamp has a low output intensity. A number of examples of this method are given below. They all share the disadvantage that additional power is needed for the additional light source. Also, whenever additional light is added to a projector system, either the entrance aperture of the system must be made larger (leading to less efficient light usage), or a spectrally or angularly selective reflector must be used (leading to some loss of light from the UHP lamp).

In U.S. Pat. No. 6,561,654, light from a semiconductor laser is combined with light from a UHP lamp using a spectrally selective reflector. There are a number of disadvantages of this approach. A high power laser is required, adding to the expense of the system and imposing requirements for cooling and power. A narrow bandwidth laser line will lead to speckle on the projected image. The spectrally selective reflector inserts light from the laser into the projector system, but removes from the projection system light in the same wavelength range from the UHP lamp.

A similar approach is described in U.S. Pat. No. 6,398,389, where the additional light source is a solid-state light source.

WO 02/101459 describes a similar scheme where light is coupled from an additional source into an integrator rod by a prism or grating. Further embodiments include direct coupling of auxiliary light into the arc of the main lamp.

U.S. Pat. No. 6,623,122 describes an illumination system for a projector comprising two or more lamps with mutually differing spectral distributions, and a condensing optical system which synthesizes the light from the two or more sources. The patent describes embodiments using two lamps, and in particular a combination of a halogen lamp and a high pressure mercury lamp. The illumination system is bulky, which substantially increases the size of the image projector, and it is inefficient.

An alternative approach to increasing the brightness of an image projector has been described by D. Dewald, S. Penn and M. Davis in “Sequential Colour Recapture and Dynamic Filtering: a Method of Scrolling Colour”, SID2000 Digest, 40.2 and U.S. Pat. No. 6,591,022. A display device of this prior art comprises a light source 1, a recycling integrator rod 3, a spiral colour wheel 4 acting as a sequential colour filter, and a DMD chip 6, as shown in FIG. 2a.

The integrator rod 3 has a mirror coating 10 disposed on part of its input face 3a, leaving a circular transparent area not covered as indicated in FIG. 2a. The transparent area is necessary to allow light to enter the integrator rod, and light from the light source 1, for example a small arc lamp, is directed onto the part of input face 3a of the integrator not covered by the mirror coating 10 by a lens 9 or other means. Light is homogenised as it passes along the integrator rod 3, and is emitted with an intensity that is substantially uniform over the area of the exit face of the integrator. A colour wheel 4 having one or more strips that are transmissive only to red light (“red strips”), one or more strips that are transmissive only to blue light (“blue strips”) and one or more strips that are transmissive only to green light (“green strips”) is placed in the path of light from the integrator 3. The red, green and blue strips are imaged onto a modulator 6 such as a DMD by an optical system indicated generally at 5, and scroll across the area of the DMD as the colour wheel 4 slowly rotates.

The principle of operation is illustrated schematically in FIG. 2a, FIG. 2b is a perspective view showing the projection system, and FIG. 2c is an end view of the colour wheel.

The colour wheel of FIG. 2c has sets of three or four colour filters, whose boundaries form a “spiral of Archimedes”. Each set includes one filter for each of the primary colours, and a clear, or white, segment that allows all visible light to pass through it. Each primary colour segment transmits one of the primary colours and reflects the other two primary colours. FIG. 2c shows the colour wheel as having two sets each of four filters, with each set containing one clear filter (“W”), one red-transmitting filter (“R”), one green-transmitting filter (“G”) and one blue-transmitting filter (“B”); the filters are labelled “1” or “2” to indicate to which set they belong. The spirals are designed and aligned to the spatial light modulator such that the tangent of the boundaries between adjacent segments is approximately parallel to the rows of the spatial light modulator. The number of RGB stripes determines the speed of rotation of the colour wheel.

When the white light propagating within the integrator 3 reaches the colour wheel 4, light of a given colour (red, for example) is transmitted through the corresponding section of the wheel, which reflects the green and blue light towards the input end 3a of the integrator. The light is homogenised as it propagates along the integrator, and so has an intensity that is substantially uniform over the area of the integrator when it reaches the input face 3a of the integrator. Any blue or green light that is incident on a part of the input face 3a of the integrator that is covered by the mirror coating 10 will be reflected and will propagate back along the integrator 3, whereas any light that is incident on a part of the input face 3a of the integrator that is not covered by the mirror coating 10 will pass out of the integrator 3. (Typically, the aperture in the mirror coating 10 is sized so that the mirror coating will reflect approximately ⅔ of the G and B light back into the integrator.) The reflected G and B light is homogenised again as it propagates through the integrator towards the exit face 3b, and may be transmitted by a corresponding G or B segment of the colour wheel as described above. This process is repeated until all the light that entered the input aperture from the lamp is either transmitted to the modulator, lost or scattered, as illustrated in FIG. 2a.

There are a number of disadvantages of this approach, associated with the size of the transparent area at the entrance face of the integrator rod. If only a small area of the input face 3a of the integrator rod is transparent, then recycled light is efficiently reflected back towards the exit face 3b of the integrator rod; in this case, however, light can not be coupled efficiently into the integrator rod from the lamp. In practice, the integrator rod is enlarged in diameter so that the transparent part of the entrance face 3a has approximately the same cross-sectional area as an ordinary (non-recycling) integrator rod, and the cross-sectional area of the entire rod is approximately three times as large as the cross-sectional area of an ordinary (non-recycling) integrator rod. The étendue of the light emitted by the integrator is therefore increased by a factor of three, making projector design more difficult and lowering the light efficiency. Also, the larger size of the integrator rod leads to a larger projector.

Although colour re-capture described in this prior art increases light throughput, it does not reduce the red deficiency of the illuminator and so it does not improve the colour balance of the projected image.

Polychromatic light from a UHP lamp also contains radiation in the ultra-violet (UV) and infra-red (IR) spectral regions outside the visible spectrum, as shown in FIG. 1. This light is not used to form a projected image and is often removed by UV/IR cut-off filters placed immediately after the lamp to reduce degradation effects to the downstream optical elements of the image projector.

Spectral conversion of invisible UV and IR radiation to visible light is known and can be found in number of publications, for example:
F. Auzel et al, “Rare earth doped vitroceramic: new efficient, blue and green materials for infrared Up-Conversion”, J. Electrochem. Soc.: Solid State Science and Technology, Vol. 122, No. 1, pp. 101-107, 1975;
W. Miniscaico, “Optical and Electronic Properties of rare earth ions in glasses”—in “Rare earth doped fiber lasers and amplifiers”, ed. by M. Digonnet, NY, 1993;
U.S. Pat. No. 5,585,640 “Glass matrix doped with activated luminescent nanocrystal particles”; and
U.S. Pat. No. 6,207,229 “highly luminescent colour-selective materials and method of making thereof”.

EP-A-0 199 409 describes luminescent aluminoborate and/or aluminosilicate glass which is activated by rare earth metals for a luminescent screen in discharge lamps or cathode-ray tubes. These luminescent glasses contain Tb³⁺or Ce³⁺as an activator and have high quantum efficiency upon UV excitation.

A few recently published Japanese patent applications suggest using part of the UV or IR emission of the arc lamp in wavelength converting elements in a projector.

Thus, JP 2001-264880 teaches the use of wavelength converting elements, which change UV radiation emitted by an arc lamp to blue light and changes IR radiation to red light, to improve colour balance of a 3-panel LCD image projector. Two suggested embodiments of this prior art are shown in FIGS. 3a and 3b. Wavelength converting elements 14, 17 and 18 are of a filter-type and are arranged within colour separation optics. In one embodiment of this prior art schematically shown in FIG. 3a, a wavelength converting element 14 is arranged between a lamp 1 and a condensing lens 16. The wavelength converting element 14 is described as rare-earth doped glass element which changes UV radiation to blue light and which changes IR radiation to red light.

In the embodiment illustrated in FIG. 3b, wavelength converting filters 17 and 18 are placed in front of transmissive LCDs 19, 20. The wavelength converting filter 17 changes the IR radiation emitted by the lamp 1 to red light, and also changes the yellow light emitted by the light (the output spectrum of the lamp has a peak in the yellow region of the spectrum) to red light. The patent application does not give details of implementation of such a filter. The wavelength converting filter 18 changes the UV radiation emitted by the lamp 1 to blue light.

As the fluorescent material of a wavelength converting filter in this prior art emits over the full solid angle subtended by the filter, the collection efficiency of the converted spectral component is very low since the projection system is designed for a limited angular cone of illumination light. For example, a typical acceptance half-angle for an LCD panel in a projector might be of order θ=3 degrees. Much less than 1% of light from an isotropic source, such as a wavelength-converting filter, would be emitted into this cone so that over 99% of the output of a wavelength-converting filter would be wasted. This prior art LCD projector also does not use polarisation conversion and homogenisation optics and suffers from low efficiency of light utilisation and brightness non-uniformity. Furthermore, any polarisation conversion optics placed before the wavelength converting elements would be destroyed by UV and IR radiation emitted by the lamp 1.

Japanese Patent Application JP2002-90883 suggests using an integrator rod as a wavelength converting element to reduce the red deficiency of an arc lamp in an image projector by changing the UV radiation from the lamp to red or green light. This prior art is shown in FIG. 4. The beam from an arc lamp 21 is focussed onto input face 24 of a glass rod 22 doped with Eu²⁺, Eu³⁺, Tb³⁺ or Er³⁺ where it is homogenised by multiple reflections off the walls of the rod, which acts as an integrator rod. The glass rod 22 is surrounded by a reflective mirror 23. Part of the UV and IR radiation from the light 21 is converted into light having a wavelength inside the visible region inside the rod, and the proportion of UV/IR radiation in light exiting the rod 22 through its exit surface 25 is reduced, as the red or green spectral component is increased.

However, the overall improvement in colour balance in a projection system with such a wavelength converting element is again very small, because the fluorescent material of the integrator rod 22 emits light over the full solid angle subtended by its exit face 25. The performance is slightly better in an integrator rod than adjacent to an LCD panel, because the exit face of an integrator rod is magnified by the collection optics in a projector when it is imaged onto the display panel. However, the collection lens has an F-number of at least 1, implying that it can gather less than 3% of the emitted light from an isotropic source.

Furthermore, due to the low broadband absorption cross-section of rare-earth ions, a substantial part of the UV and IR radiation propagates through the integrator rod 22 unconverted, and is lost from the system.

To improve efficiency of utilisation of emitted light in a projection system with wavelength converting integrator rod, WO 2004/046809 suggests to shape the light receiving face 3a of an integrator rod 3 as a parabolic or elliptical reflector 3c as illustrated in FIG. 5. Fluorescent material is placed in a focal point F2 of such a reflector. Light from the lamp 1 is focused into the focal point F2, and the shaped end of the integrator reflects the resulting fluorescence into a useful path in the projector (a reflective coating 3e may be applied over part of the input face of the rod 3 to enhance the reflection). The problem of the selection of a small acceptance angle from an isotropic source, which leads to low efficiency in patent applications JP 2001-264880 and JP2002-90883, is therefore reduced.

However, to couple light from the lamp 1 into the integrator rod 3, the non-reflective aperture 3d where the reflective coating 3e is not present must be much larger than the focussed spot size. The size of the integrator rod is therefore substantially increased by this system. A further difficulty with this proposal is the low absorption cross-section of the fluorescent material integrated into the glass rod 3. Inorganic Eu³⁺ compounds suggested for UV to red wavelength conversion have a very low cross section and, therefore, little UV light is absorbed across the small volume where the end reflector of the integrator rod acts effectively. The efficiency of UV light utilisation is low. If fluorescent material is highly concentrated in an attempt to solve this problem, the efficiency of photoluminescence suffers due to concentration quenching.

WO 2001/27962 describes how a “funnel” structure 11 (illustrated in FIG. 6) is used to direct light from an electrodeless discharge lamp 1. The electrodeless lamp 1 is placed in an enclosure 12, and the funnel structure 11 is coupled to the enclosure 12.

U.S. Pat. No. 6,227,682 describes a tapered integrator rod 13 which is used together with a separate retroreflector 15 to provide a high-efficiency illumination system for a projector. Again this tapered structure is separate from the light source 1 (an arc tube) and light must therefore be coupled into the tapered integrator rod 13 from the light source, leading to unavoidable loss of light. This arrangement is shown in FIG. 7.

In U.S. Pat. No. 6,227,682, a tapered integrator rod is used rather than an integrator rod of uniform cross-section so that the arc of the lamp 1 is imaged into the integrator rod without magnification or reduction (1:1 imaging). The image formed at the entrance face 13a of the integrator rod is therefore relatively small and has a wide range of ray angles (large divergence). However, the requirement for light incident on the light modulator is for a larger illuminated area with a smaller range of ray angles. The tapered integrator has the function of making the optical intensity pattern uniform while simultaneously transforming the optical intensity from a small area with high divergence to large area with small divergence.

### SUMMARY OF THE INVENTION

A first aspect of the present invention provides a light source system comprising: a light source; and a non-imaging optical element, the non-imaging optical element having an output surface; wherein the light source is disposed within the non-imaging optical element.

The field of non-imaging optics is a well-known technical field. It is described by, for example, Welford and Winston in “High collection nonimaging optics”, Academic Press (1989). Non-imaging optical systems were originally developed as light concentrators, for example for collecting sunlight or radiation emitted by high-energy particle collisions, and concentrating the light or radiation onto a exit aperture that is smaller than the entrance aperture of the light concentrator.

Prior art illumination systems having a reflector disposed adjacent to the light source, such as the illumination system in FIG. 13, produce a direct image of the light source (which may be at infinity if the reflector is shaped to emit collimated light). A typical light source emits light with an intensity that varies over the area of the light source, and these intensity variations will be reproduced in the direct image of the light source produced by the reflector. It is therefore necessary to provide the integrator 22 to eliminate these variations in intensity, and provide a light output at the output face 25 of the integrator that has an intensity that is, as far as possible, uniform over the output face of the integrator. Any variations in intensity over the output face of the integrator will result in variations in intensity over the area of the projected image.

A non-imaging optical element as used in a light source system of the present invention does not, in contrast, produce a direct image of the light source. The light output at the output surface of the non-imaging optical element has an intensity that is substantially uniform over the area of the output surface, and the integrator 25 of the prior art may thus be omitted. A light source system of the invention is therefore smaller and lighter than a prior art system of the same output power.

A further feature of the invention is that the light source is positioned within the non-imaging optical element. The non-imaging enclosure is optical element so as to direct light to the output surface of the optical element, so that there is very good coupling between the light source and the output surface of the non-imaging optical element. In contrast, in a conventional system having a lamp, a reflector and an integrator rod there are unavoidable coupling losses between the lamp and the integrator rod. Moreover, it is necessary to align the lamp and reflector with the integrator rod in order to provide the greatest possible coupling of light into the integrator, and this can be difficult and time-consuming to do. In the present invention, however, no alignment of a lamp to an integrator rod is required. The light source is positioned in the non-imaging optical element, and may be secured at its desired location within the optical element—and good coupling of light to the output surface of the non-imaging optical element is assured.

The non-imaging optical element may have a first end and second end; wherein the second end of the optical element is open and defines the output surface of the non-imaging optical element; and wherein the light source is disposed at or near the first end of the non-imaging optical element. Placing the light source at or near the opposite end of the optical element to the output face of the optical element means that the light output from the output surface of the optical element will have an intensity that is uniform, or nearly uniform, over the area of the output surface.

The non-imaging optical element may be closed at the first end. This prevents light being lost through the first end of the optical element.

The non-imaging optical element may be a reflective optical element.

The non-imaging optical element may have an angular light output range at the output surface that is lower than the angular light output range of the light source.

The non-imaging optical element may be a tapered light guide.

The non-imaging optical element may comprise a plurality of planar surfaces. A cross-section through the non-imaging optical element may be substantially rectangular.

A longitudinal section through the non-imaging optical element may comprise a parabolic section. The non-imaging optical element may be a compound parabolic concentrator.

The non-imaging optical element may have a first end, the longitudinal section of the first end being substantially a part of a circle; and the light source may be provided near the first end of the optical element. The light source may be positioned substantially at the centre of the part of the circle.

The light source system may further comprise a wavelength conversion material, the wavelength conversion material being provided within the non-imaging optical element.

The wavelength conversion material may convert radiation having a first wavelength into radiation having a second wavelength, the second wavelength being shorter than the first wavelength.

The wavelength conversion material may be provided near the first end of the non-imaging optical element.

The light source system may comprise a reflector provided in the non-imaging optical element in a path of light from the light source to the output face of the optical element, the reflector reflecting, in use, light in at least a first wavelength range and transmitting light in at least a second wavelength range.

The wavelength conversion material may be provided in a path of light from the light source to the reflector.

The reflector may have a first surface; wherein the first surface of the reflector generally faces the light source; and wherein the wavelength conversion material is provided on the first surface of the reflector.

The enclosure may be provided with at least one edge reflector, the at least one edge reflector being crossed with the longitudinal axis of the enclosure.

The non-imaging optical element may be so shaped that light entering the optical element at its output face is reflected within the optical element so as to be re-emitted from the output face of the optical element.

The light source may be a discharge light source. It may be a high pressure discharge light source.

A second aspect of the invention provides a light source system comprising: an array of at least first and second light sources; and at least first and second non-imaging optical elements, the first and second light sources being disposed within a respective one of the first and second non-imaging optical elements; wherein each of the first and second non-imaging optical elements has an output surface; and wherein the output surface of the first non-imaging optical element is substantially contiguous with the output surface of the second non-imaging optical element.

The first non-imaging optical element may have a first longitudinal axis; the second non-imaging optical element may have a second longitudinal axis; and the first longitudinal axis may be parallel to the second longitudinal axis.

The output surface of the first non-imaging optical element and the output surface of the second non-imaging optical element may lie in a common plane.

A third aspect of the invention provides an image projection system comprising a light source system of the first aspect.

A fourth aspect of the invention provides an image projection system comprising a light source system of the second aspect.

The image projection system may further comprise a wavelength separator; and a spatial light modulator; and the wavelength separator may be disposed within a path of light from the light source system to the spatial light modulator.

The image projection system may further comprise a first lens, the first lens being disposed within a path of light from the light source system to the wavelength separator.

The first lens may have a first focal length; the separation between the output face of the light source system and the first lens may be substantially equal to the first focal length; and the separation between the first lens and the wavelength separator may be substantially equal to the first focal length.

The image projection system may further comprise a second lens, the second lens being disposed within a path of light from the wavelength separator to the spatial light modulator.

The second lens may have a second focal length; the separation between the wavelength separator and the second lens may be substantially equal to the second focal length; and the optical path length between the second lens and the spatial light modulator may be substantially equal to the second focal length.

The second focal length may be substantially equal to the first focal length.

The wavelength separator may be a colour wheel.

### BRIEF DESCRIPTION OF THE FIGURES

Preferred embodiments of the invention will now be described with reference to the accompanying drawings, in which:

FIG. 1 shows a typical spectrum of an UHP lamp;

FIG. 2a is a schematic illustration of a known illumination system with sequential colour re-capture;

FIG. 2b is a perspective view of the illumination system of FIG. 2a;

FIG. 2c is an end view of a colour wheel of the illumination system of FIG. 2a;

FIGS. 3a and 3b are plan-sectional diagrams of known types of LCD projector including wavelength converting filters;

FIG. 4 is a plan-sectional diagram of another known type of image projector including a glass rod integrator doped with rare earth ions;

FIG. 5 is a plan-sectional diagram of a known type of illumination system comprising modified fluorescent rod;

FIG. 6 is a cross-sectional diagram illustrating the structure of a known lamp system of the type disclosed in WO 01/27962;

FIG. 7 shows a known illumination system for a projector that uses a tapered integrator rod;

FIGS. 8a(i) to 8a(iv) shows a light source system according to one embodiment of the present invention;

FIG. 8b illustrates operation of the light source system of FIGS. 8a(i) to 8a(iv);

FIGS. 9a to 9d show light source systems according to further embodiments of the present invention;

FIG. 10a is a sectional illustration of a light source system according to a further embodiment of the present invention;

FIG. 10b is a sectional illustration of a light source system according to a further embodiment of the present invention;

FIG. 11a shows a colour wheel suitable for use with a light source system of the present invention;

FIG. 11b illustrates colour re-circulation in a light source system of the present invention;

FIG. 11c is a block schematic diagram of an image projection system according to the present invention;

FIGS. 12a and 12b illustrate arrays of light-emitting diodes;

FIGS. 12c and 12d are front and side views of a light source system according to a further embodiment of the present invention;

FIG. 13 is a block schematic diagram of a known current commercial projector design;

FIG. 14 is a block schematic diagram of an image projection system according to the present invention; and

FIGS. 15a and 15b are block schematic diagrams of another image projection system according to the present invention.

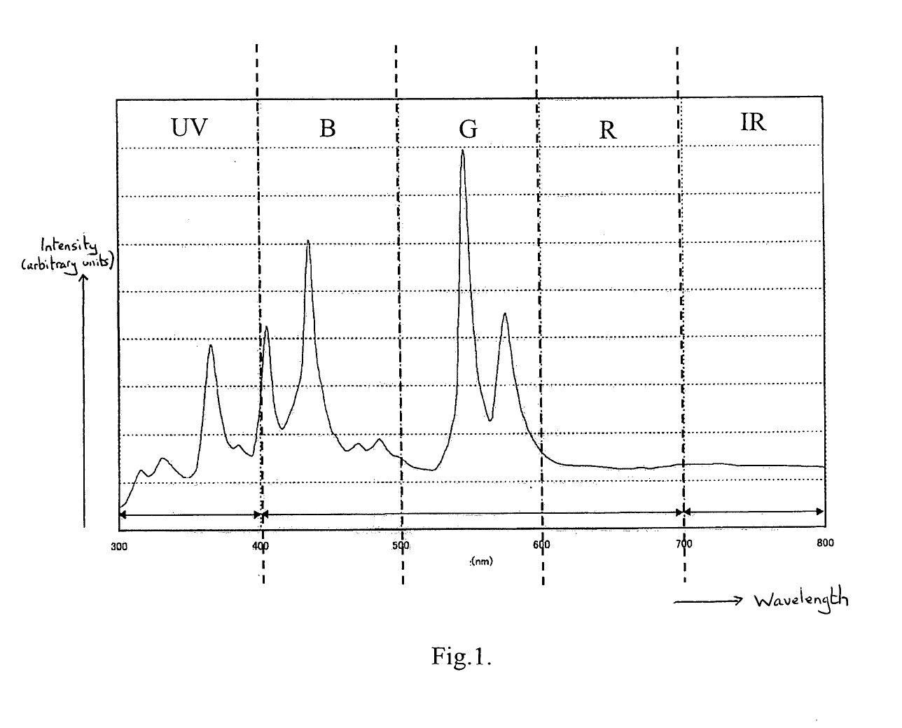

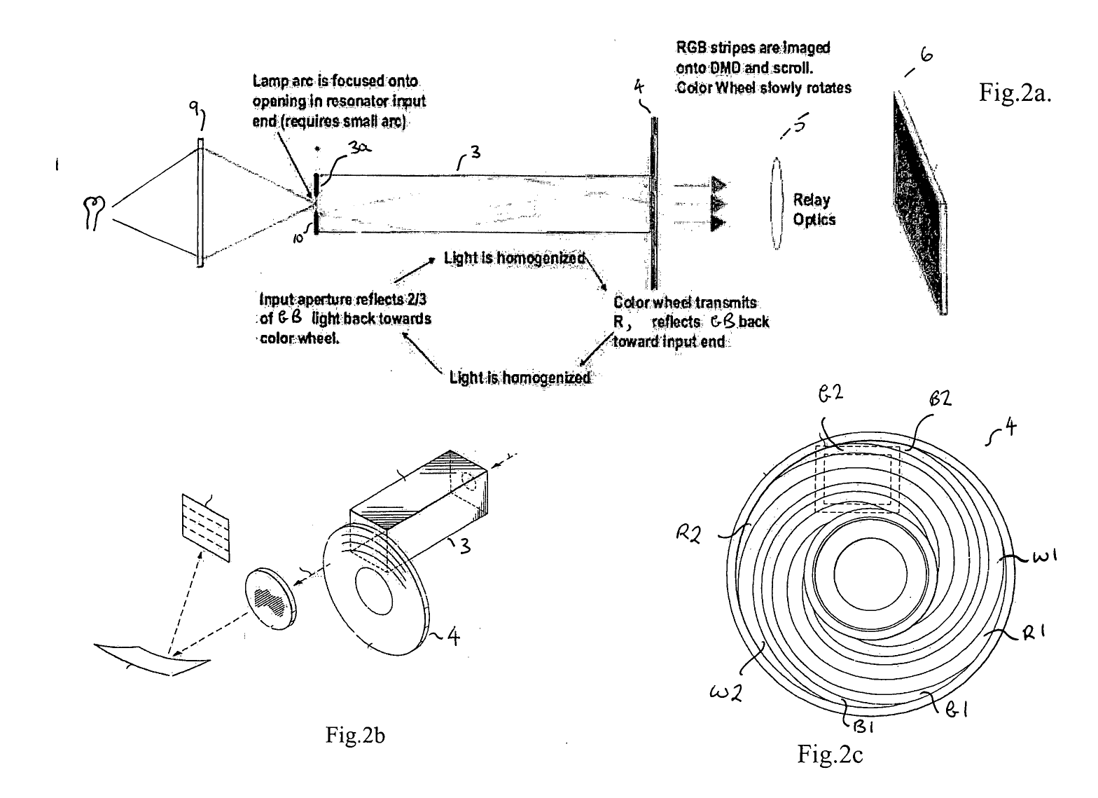

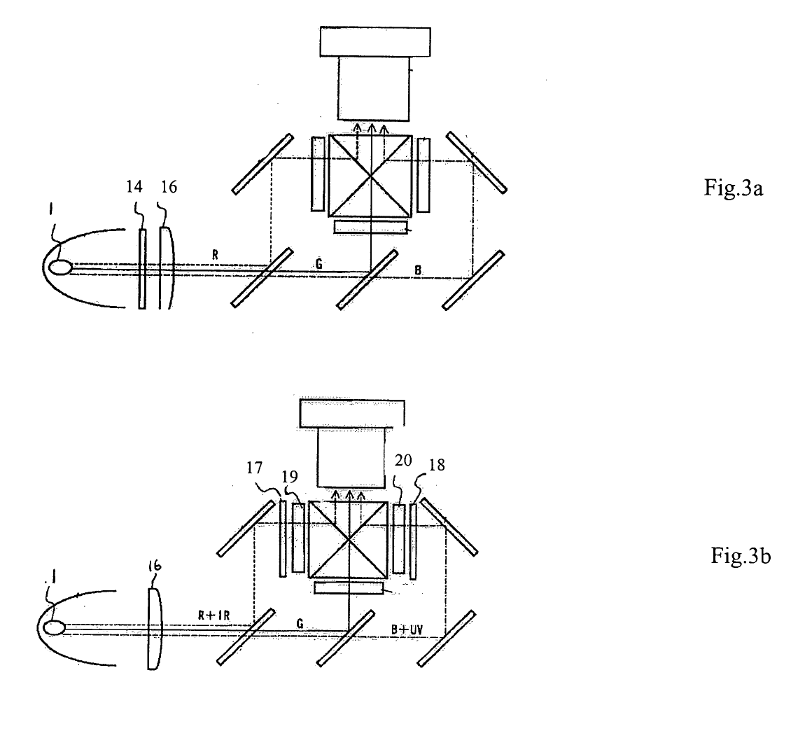

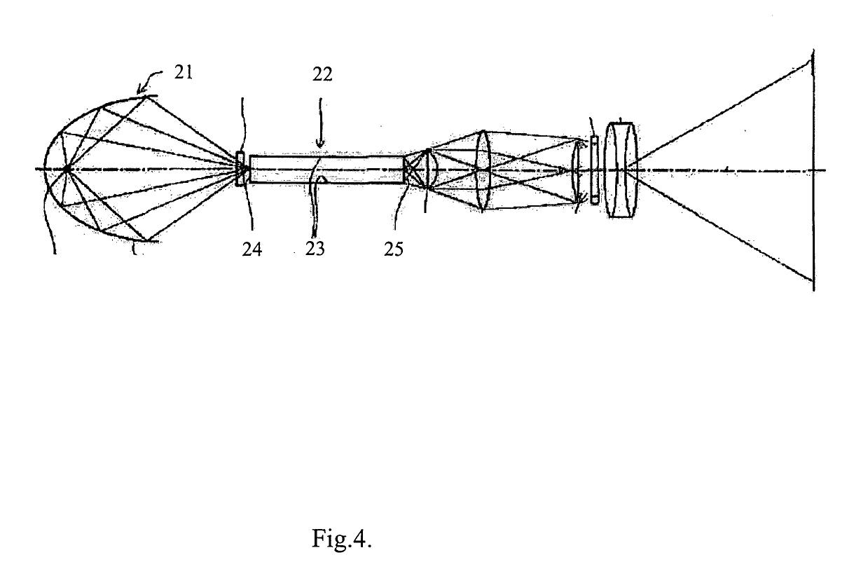

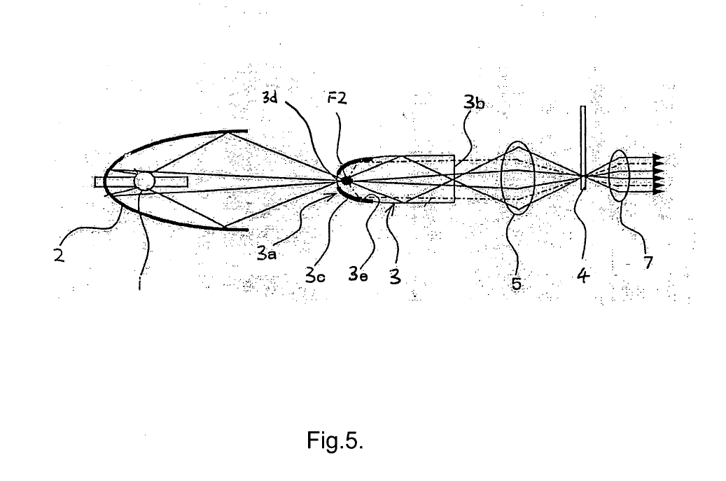

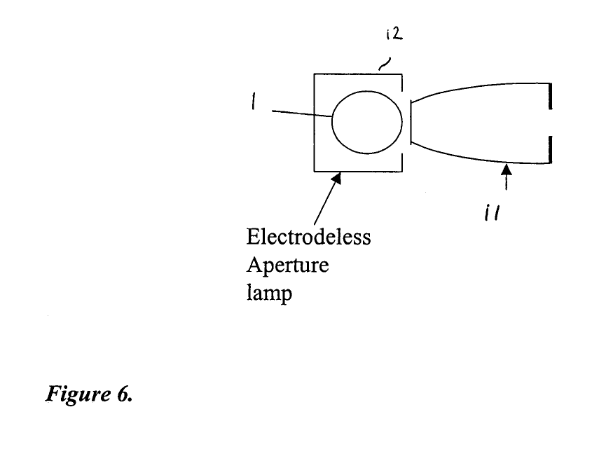

### DETAILED DESCRIPTION OF THE PREFERRED EMBODIMENTS

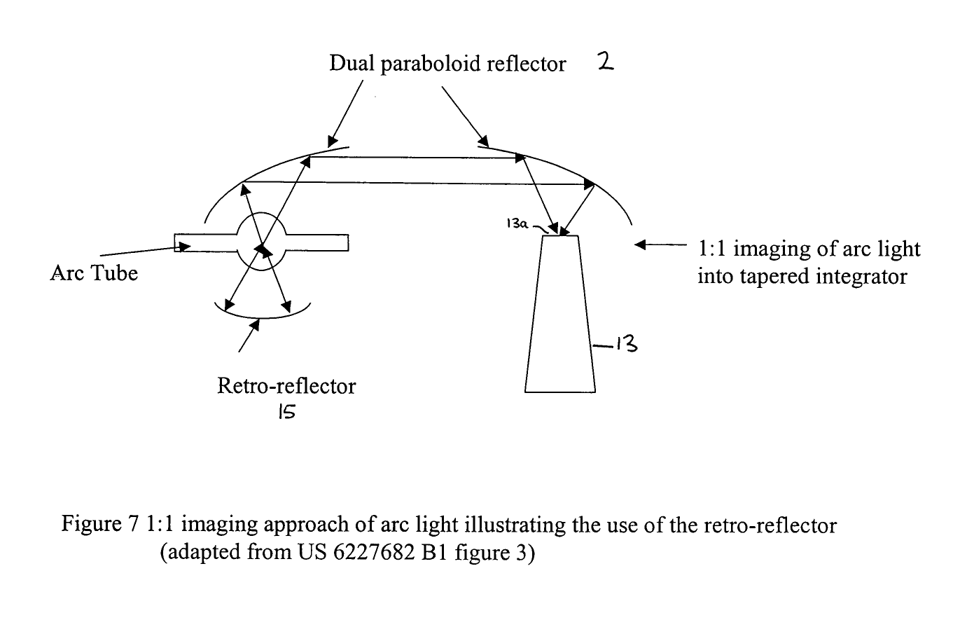

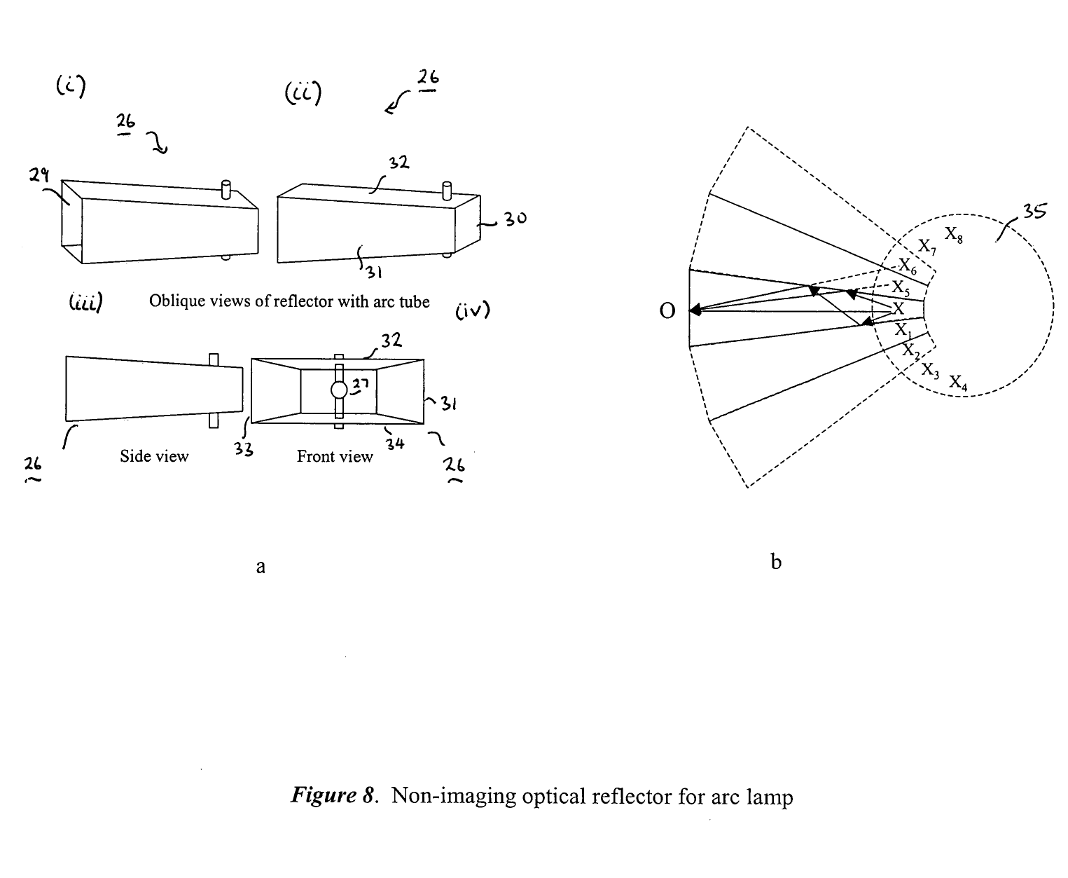

FIGS. 8a(i) to 8a(iv) illustrate a light source system 26 according to a first embodiment of the present invention. The light source system comprises a light source 27 and an optical element 28 having a first end that is preferably closed and a second end that is open to define an output face 29. The light source 27 is mounted within the optical element 28, at or near the first end of the optical element, and is thereby spaced from the output face 29. The light source 27 may consist of, for example, a discharge tube, and may for example consist of a high-pressure discharge tube of the type well known and currently used in projectors. FIGS. 8a(i) and 8a(ii) are perspective views of the light source system, FIG. 8a(iii) is a side view of the light source system, and FIG. 8a(iv) is an end view of the light source system, looking into the optical element from the output face.

The optical element 28 is a non-imaging optical element. The optical element 28 does not form a real image of the light source 26, but produces an output light field, at the output face 29, that is substantially homogenous—i.e., that has an intensity that is substantially uniform over the area of the output surface. The output wavefield from the light source system may therefore be coupled directly into the optical system of a projector, and there is no need to provide an integrator rod.

In this embodiment, the non-imaging optical element 28 has the form of an enclosure. The light source 27 is positioned within the non-imaging enclosure. The non-imaging enclosure 28 is shaped so as to direct light to the output surface of the enclosure, so that there is very good coupling between the light source 27 and the output surface 29 of the enclosure.

The light source 27 is preferably secured in position within the enclosure, and is fixedly mounted to the enclosure. This may be done in any suitable manner. It is important that the light source 27 is mounted in such a way as to withstand any differential thermal expansion between the light source and the enclosure that occurs when the light source system is in use. It is also important that heat generated by the light source in use can be adequately dissipated.

The enclosure is preferably a reflective enclosure (that is, the surfaces of the walls of the enclosure are preferably reflective for light propagating within the enclosure), so that light propagating within the enclosure is homogenised by undergoing reflection at one or more walls of the enclosure. The enclosure 28 may be constructed from a non-reflective material such as glass and coated on its internal surface and/or on its external surface with a reflective material such as silver or aluminium. Alternatively the reflector may be made from a reflective material (such as aluminium). Alternatively the reflector may be made from a metal which has suitable thermal properties (such as coefficient of thermal expansion, thermal conductivity), such as copper, and coated with a reflective material.

One example of a reflective enclosure suitable for use with an arc discharge light source is shown in FIGS. 8a(i) to 8a(iv). This reflector has five planar surfaces. There is one rectangular surface 30, which forms an end face of the enclosure spaced from and parallel to the output face 29 of the enclosure. The other four surfaces 31-34 of the enclosure are each trapezoidal in shape, and the enclosure 28 has rectangular symmetry along its central axis. A cross-section through the enclosure 28, perpendicular to its longitudinal axis, is rectangular, and the area of the cross section increases moving away from the light source 27 towards the output surface 29 of the enclosure. An enclosure of this shape may be referred to as a “tapered light guide” or as a ‘horn’, by analogy with microwave horns.

One advantage of this enclosure shape is that it provides a light output that is very well homogenised across the area of the outface face of the enclosure, for the same reason as a standard integrator rod. Light from the light source is re-imaged by multiple reflections from the reflective surfaces of the enclosure so that, to an observer in the plane of the output surface 29, illumination appears to come from multiple images of the light source 27 located at a wide range of positions. This tends to average out any non-uniformity in the light distribution over the area of the output face, so that the intensity of illumination is substantially uniform over the area of the output surface 29.

FIG. 8b illustrates this effect. A light source X is imaged through multiple reflections at the surfaces of the enclosure so that an observer at position O sees many virtual images X₁, X₂ . . . of the light source as a result of reflections in the surfaces 31-34 of the enclosure, in addition to seeing light emitted by the source X that is transmitted directly towards the observer. Images X₁ and X₅ involve one reflection at a surface of the enclosure, images X₂ and X₆ involve two reflections, and so on. The number of virtual images seen by an observer depends upon the geometry of the reflector.

It may also be seen from FIG. 8b that the images X₁, X₂ . . . of the light source are all contained within a region 35 (bounded by the circle drawn in broken lines in the figure) which subtends a limited angle as seen from the observer position O. The range of ray angles in the light is therefore reduced as light passes down the reflective enclosure 28 from the narrow end to the wider end. The light source radiates light in all directions, but the angular spread of the light beam is reduced as the light propagates along the enclosure so that light emerges from the output surface 29 of the reflective enclosure 28 with a limited range of ray angles.

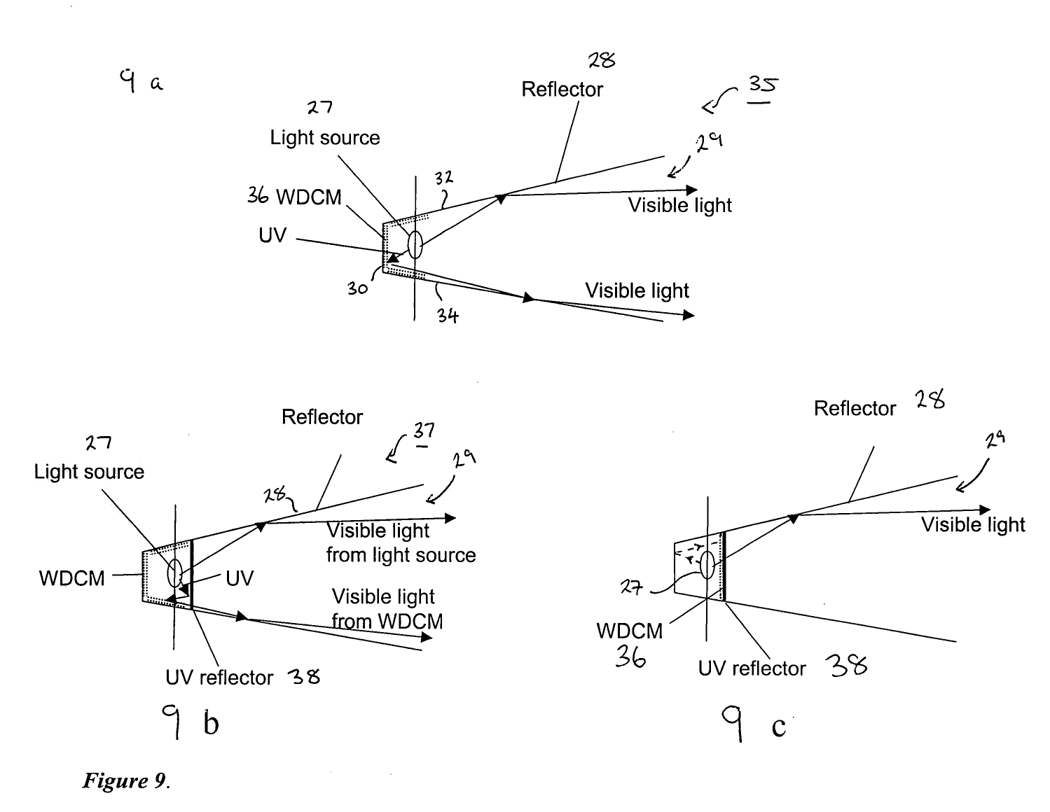

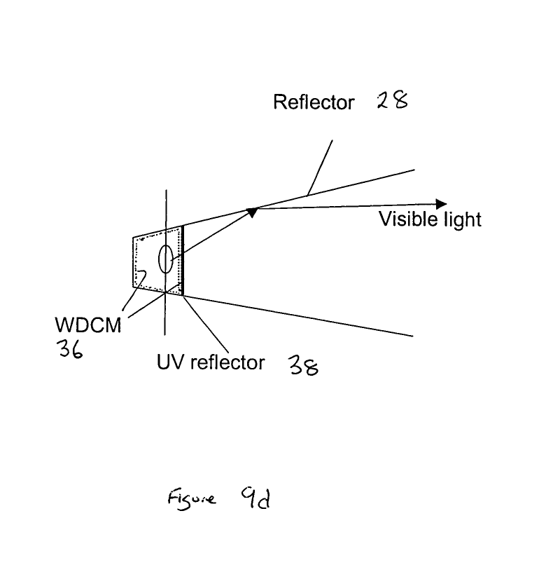

In a further embodiment of the invention, the light source system further comprises a wavelength conversion material. The wavelength conversion material is provided within the enclosure. A light source system according to this embodiment is shown in FIG. 9a, which is a cross-section through the light source system.

In the light source system 35 of FIG. 9a, a light source 27 is disposed within a non-imaging enclosure 28. The enclosure 28 of FIG. 9a is similar to the enclosure of FIGS. 8a(i) to 8a(iv), and has a first, closed end and a second end that is open to define an output face, and the light source is positioned near the first end of the enclosure. A wavelength conversion material 36 is provided within the enclosure 28, at or near the first end of the enclosure. The wavelength conversion material 36 converts radiation in a first frequency range to radiation in a second frequency range—that is, when the wavelength conversion material 36 is illuminated by radiation within the first frequency range it re-emits radiation in the second frequency range.

In a preferred embodiment, the wavelength conversion material 36 is a wavelength conversion material that, when illuminated by radiation in a frequency band outside the visible spectrum, re-emits light in a frequency band within the visible spectrum. Thus, light emitted by the light source 27 outside the visible region of the spectrum is converted to visible light by the wavelength conversion material 36, thereby increasing the intensity of the output of the light source system in the visible region of the spectrum. The visible light re-emitted by the wavelength conversion material 36 is reflected by the interior surfaces of the reflective enclosure 28 in the same way as visible light emitted by the light source 27, and so is emitted from the enclosure with a low angular range.

In a particularly preferred embodiment, the wavelength conversion material 36 is a wavelength conversion material that, when illuminated by UV (ultra-violet) radiation, re-emits light in a frequency band within the visible spectrum. Such a wavelength conversion material is know as a wavelength down conversion material, since it re-emits light at a longer wavelength than the wavelength at which it is illuminated.

In principle, the wavelength conversion material 36 could be a wavelength up conversion material that re-emits light in a frequency band within the visible spectrum when illuminated by IR (infra-red) radiation. wavelength up conversion materials generally have a low conversion efficiency. Moreover, currently available discharge lamps produce very little output radiation in the IR region of the spectrum.

The wavelength conversion material 36 is preferably disposed at or near the first, closed end of the enclosure 28, so that visible light re-emitted by the wavelength conversion material is reflected by the interior walls of the enclosure before it reaches the output face 29 of the enclosure. An advantage of this placement is that wavelength conversion material placed close to the first end (that is, the closed end) of the enclosure produces light which is then processed by reflection from the surfaces of the enclosure to give a homogeneous intensity profile and a narrow range of ray angles, just as visible light from the light source is processed; if the wavelength conversion material were disposed at or near the output face 29 of the enclosure, visible light re-emitted by the wavelength conversion material would have a wide angular range when emitted from the output face 29 of the enclosure. Also, by placing the wavelength conversion material on the surface of the reflector it is sufficiently far away from the light source 27 so that high temperatures and optical intensities at the light source 27 do not cause degradation of the wavelength conversion material 36. A further advantage is that the wavelength conversion material 36 may benefit from cooling by conduction of heat into the reflective enclosure.

In the embodiment of FIG. 9a the enclosure 28 is an enclosure of the type shown in FIGS. 8a(i) to 8a(iv). The wave wavelength conversion material 36 is preferably disposed on the interior of the end surface 30, and on portions of the four trapezoidal surfaces 31-34 close to the end surface 30.

One example of a suitable wavelength conversion material is a europium-based phosphor which converts UV light into red light in an emission band centred around a wavelength of approximately 610 nm. Use of a wavelength conversion material that converts UV light into red light has the advantage of increasing the intensity of red light, relative to the intensity of green light and blue light, in the light output from the light source system, thereby improving the colour balance and reducing the red deficiency. The invention is not, however, limited to this particular material and any suitable red-emitting phosphors may be used as the wavelength conversion material in this embodiment of the invention. Unlike the prior art systems where a fluorescent material is incorporated in the integrator rod (e.g. JP2002-90883, described above), it is not necessarily for the wavelength conversion material to be transparent to visible light.

Alternatively, inorganic phosphors such as, for example, ZnS, CdSe or CdTe phosphors, may be used as a wavelength conversion material. Inorganic phosphors may be in a form of quantum dots, such as available from Evident Technologies, Inc.

A window 38 which reflects UV light and transmits visible light may be placed in the reflective enclosure in a position where it causes UV light which would not otherwise be absorbed by the wavelength conversion material to be reflected back onto the wavelength conversion material. This increases the proportion of the UV light from the light source 27 which is converted by the wavelength conversion material into visible light, and so increases the intensity of visible light output from the enclosure 28. FIG. 9b shows a light source system 37 according to this embodiment of the present invention.

The light source system 37 of FIG. 9b is generally similar to the light source system 35 of FIG. 9a, except that it further comprises a UV reflector 38 provided near the first end of the enclosure 28, between the light source 27 and the output face 29 of the enclosure. The reflector 38 reflects UV light, but is substantially transparent to visible light. The reflector 38 preferably extends over the entire cross-section of the enclosure 28, and is crossed with the axis of the enclosure.

In the light source system of FIG. 9a some UV light that is emitted by the light source will not be incident on the wavelength conversion material. In the embodiment of FIG. 9b, however, any UV light that is emitted by the light source will be incident either on the wavelength conversion material 36 or on the reflector 38—and any UV light that is incident on the reflector 38 will be reflected back towards the regions of the interior of the enclosure where the wavelength conversion material 36 is provided and will undergo wavelength conversion. Thus, providing the UV reflector 38 will increase the proportion of the emitted UV light that is converted to visible light, and so will increase the intensity of visible light output from the enclosure.

FIG. 9c shows a further light source system 37′ of the present invention. It is generally similar to the light source system 37 of FIG. 9b, except that the wavelength conversion material 36 is disposed on at least part of the surface of the UV reflector 38 that faces the first end of the enclosure, and preferably is disposed over the entire area of the surface of the UV reflector 38 that faces the first end of the enclosure. UV light that is emitted by the light source 27 in a direction away from the UV reflector is reflected by the enclosure and is eventually incident on the wavelength conversion material 36 disposed on the UV reflector, as shown by the light path in broken lines in FIG. 9c. UV light from the light source 27 that is incident on the UV reflector (for example because it is incident on part of the reflector 38 where the wavelength conversion material 36 is not provided) will be reflected towards the enclosure and thence back towards the reflector 38 and will eventually be incident on the wavelength conversion material 36.

In the embodiment of FIG. 9c, the wavelength conversion material 36 is preferably substantially transparent to visible light.

In a further embodiment of the invention, shown in FIG. 9d, wavelength conversion material 36 is provided both on the interior surfaces of the enclosure 28 and on the face of the reflector that faces the light source 27. In this embodiment, the wavelength conversion material 36 is again preferably substantially transparent to visible light.

FIGS. 8a(i) to 8b and 9a to 9d show a reflective enclosure 28 having a flat end face at the first, closed end and having planar side faces, a planar upper face and a planar lower face. The invention is not, however limited to this specific shape for the enclosure.

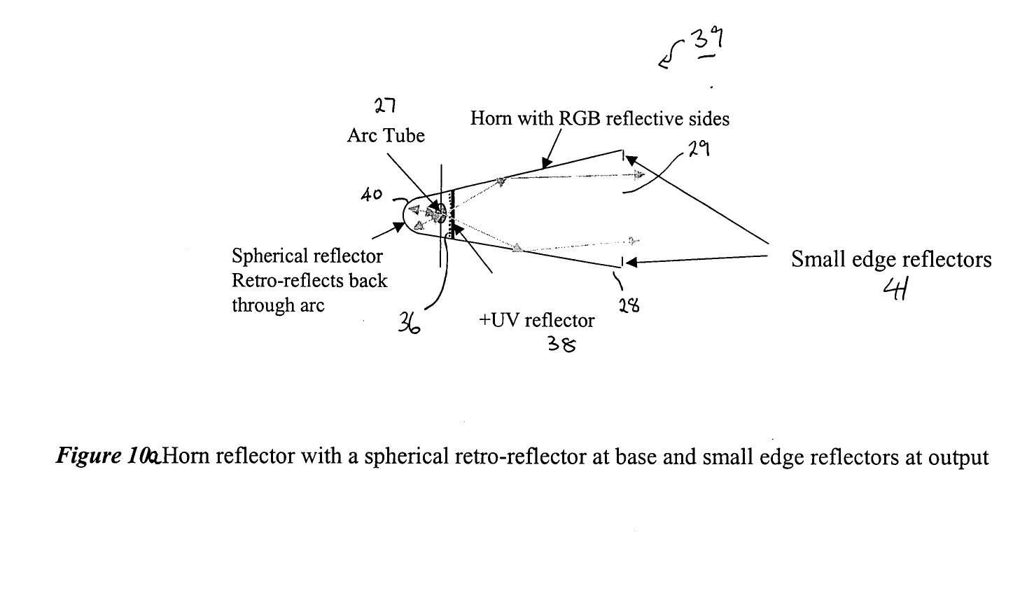

FIG. 10a is a cross-sectional view through a light source system 39 according to a further embodiment of the invention. The light source system 39 comprises a light source 27 and an non-imaging enclosure 28′ having a first end that is closed and a second end that is open to define an output face 29. The light source 27 is secured to the non-imaging enclosure 28′, at or near the first end of the enclosure, and is thereby spaced from the output face 29. In this embodiment, the first end 40 of the non-imaging enclosure has a longitudinal section (that is, a section parallel to the axis of the enclosure) that is substantially a part of a circle such as, for example, a semicircle. The light source 27 is positioned at or near the centre of the circle. The circular shape of the first end of the enclosure is such that its radius of curvature and position relative to the light source 27 causes any light reflected from the interior surface of the first end of the enclosure to be reflected through, or near to, the light source 27. This allows the shape of the non-imaging enclosure to be optimised to provide a desired angular range at the output face 29 for light emitted from the light source 29 in the forward direction (namely, towards the output face). It is known that most light will be emanating from a single point, and this means that the distribution of light at the output face of the enclosure will be simpler and easier to model and understand.

The light source system of FIG. 10a is shown as comprising a UV reflector 38 on which wavelength conversion material 36 is disposed, as described with reference to FIG. 9c above. However, the non-imaging enclosure 28′ of FIG. 10a may be applied to any of the embodiments of the invention, including the embodiments of FIG. 8a, 9a, 9b or 9d.

The light source system 39 of FIG. 10a further comprises one or more edge reflectors 41. The or each edge reflector is crossed with the longitudinal axis of the enclosure 28′, and is preferably perpendicular to the longitudinal axis of the enclosure. The or each edge reflector is provided at or near the second end of the enclosure, and is preferably in the plane of the output face of the enclosure.

The or each edge reflector 41 is provided to “clip” the profile of the output beam emitted by the enclosure, and to reflect and recirculate light at the periphery of the output beam. The edges of the output beam are likely to be the most difficult parts of the output beam to homogenise, and any variations in intensity of the output light over the area of the output surface 29 are most likely to occur, or to be greatest at, the periphery of the output surface 29. Eliminating variations in intensity of the output light at the periphery of the output surface 29, and thereby homogenising the edges of the output beam, would normally require longer enclosures. A typical enclosure might have a length that is approximately three times as great as the width of the output surface, and this should produce a reasonable degree of homogenisation of the output intensity over the area of the output surface. Increasing the ratio of the length of the enclosure to the width of the output face increases the degree of homogenisation and the directionality of the output light field, but complete homogenisation is achieved only in the limit of a very long enclosure. Providing the edge reflector(s) will eliminate the parts of the beam that are most likely to be non-homogenised, and will allow shorter enclosures to be used.

The cross-section of the enclosure is preferably chosen to match the cross section of the object that is to be illuminated. In most cases the light source system will be used to illuminate an object with a rectangular cross-section, such as a rectangular spatial light modulator, and in this case the enclosure preferably has a rectangular cross-section and particularly preferably has a rectangular cross-section with an aspect ratio that is equal to the aspect ratio of the object to be illuminated. Where edge reflectors are provided, the aperture formed by the edge reflectors again preferably matches the cross section of the object to be illuminated.

The edge reflectors may be applied to any light source system of the invention and may, for example, be applied to the light source system of any one of FIGS. 8a, 9a, 9b, 9c or 9d.

The invention is not limited to reflective enclosures with planar surfaces, nor to a reflective enclosure as shown in FIG. 10a. For example, the reflective enclosure may be in the shape of a compound parabolic concentrator, as described by Welford and Winston in “High collection nonimaging optics” (above). As is known, a compound parabolic concentrator appears in longitudinal-section (that is, a section in a plane parallel to the longitudinal axis) as two parabolic members tilted towards one another at a tilt angle. This shape has the advantage that it provides maximally efficient optical coupling between a light distribution with high divergence and small area (as in the arc of a discharge lamp) and a light distribution with low divergence and larger area (as desired at the output face of the enclosure). (Welford and Winston describe the application of these reflectors to collection of light from the sun onto solar energy gathering devices. In this case the direction of light flow through the system is reversed; light from the sun arrives at the open face of the reflector with low divergence, and is gathered into a small area with a high divergence.)

FIG. 10b is a longitudinal section through a light source system 50 according to a further embodiment of the invention. The light source system 50 comprises a light source 27 and a non-imaging enclosure 28″ having a first end that is closed and a second end that is open to define an output face 29. The light source 27 is secured to the non-imaging enclosure 28″, at or near the first end of the enclosure, and is thereby spaced from the output face 29. In this embodiment, the reflective enclosure is, as seen in section in FIG. 9e, in the shape of a compound parabolic concentrator. The upper face 51 of the enclosure has a parabolic section, and the lower face 52 of the enclosure also has a parabolic section. The end face 53 of the enclosure is planar.

It should be noted that the upper face 51 and the lower face 52 are not sections of the same parabola. If the parabola that defines the upper face 51 were continued, it would not blend smoothly into the parabola that defines the lower face 52.

The cross-section of the enclosure of the light source system 50 of FIG. 10b is preferably chosen to match the cross section of the object that is to be illuminated. (This applies to all embodiments of a light source system of the invention.)

The light source system 50 of FIG. 10b may be provided with a wavelength conversion material, for example as described with reference to any of FIGS. 9a to 9d.

Any light source system of the invention may be provided with one or more edge reflectors 41, regardless of the shape of the enclosure of the light source system.

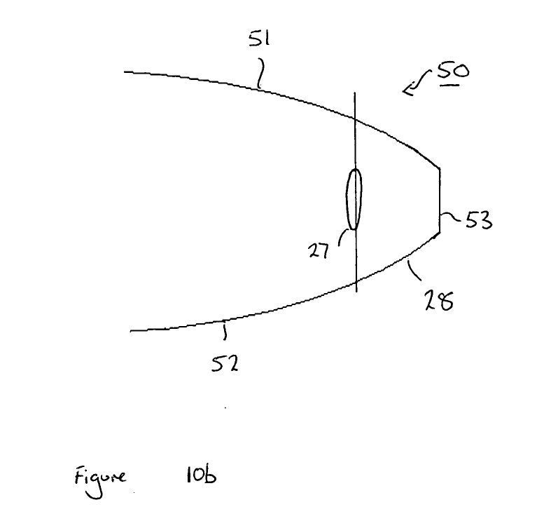

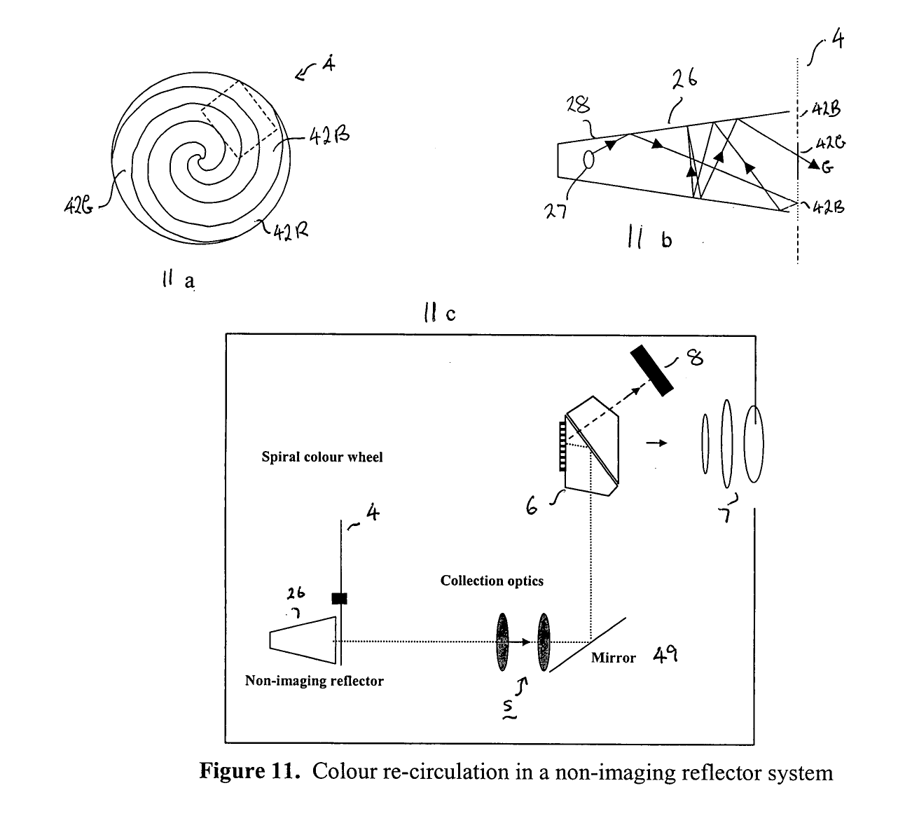

FIGS. 11a to 11c shows how a light source system of the invention can be used in a colour re-circulation system which even further increases in the efficiency and brightness of the light source.

As mentioned above, a typical image projection system contains a wavelength selector provided in may be placed in the light path to enable light of one primary colour to be selected. FIG. 11a shows a colour wheel 4, which is one example of a wavelength selector. The colour wheel is divided into a red-transmitting portion 42R, a green-transmitting portion 42G, and a blue-transmitting portion 42B. The boundary between each two adjacent portions has the form of an Archimedes' spirals. Each portion 42R, 42G, 42B reflects light of the wavelengths that it does not transmit. This is the same type of colour wheel as used in the work by Dewald et al. mentioned above (the broken rectangle in FIG. 11a denotes the SLM).

FIG. 11b is a cross-sectional view of a light source system of the present invention disposed with the output face 29 of the non-imaging enclosure 28 adjacent to a colour wheel 4 of the type shown in FIG. 11a. FIG. 11b shows a path of a green ray of light which is incident on, and is reflected by, the blue-transmitting portion 42B of the colour wheel 41. The non-imaging enclosure of a light source system of the invention is so shaped that light entering the enclosure at its output face 29 is reflected within the enclosure so as to be re-emitted from the output face 29 of the enclosure. Thus, the green light that is reflected by the blue-transmitting portion 42B of the colour wheel 41 passes into the interior of the enclosure 28 and, after undergoing reflections in the reflector, is re-emitted through the output face 29 of the enclosure. It is possible that, when the green light is eventually re-emitted from the output face 20 of the enclosure, the green light will be incident on the green-transmitting portion 42G of the colour wheel 41, as shown in FIG. 11b, and so will be passed by the colour wheel. The brightness of the light source system is thus increased compared to conventional designs. In a conventional image projection system, at least two thirds of the light is lost at the colour selector since, as an example, red and green light incident on the blue-transmitting portion of a colour wheel would be reflected by the colour wheel and would be lost. In the present invention, however, light that is reflected by the colour wheel may be re-circulated by the enclosure and may finally be transmitted by the colour wheel to be used by the projector.

The embodiment of FIG. 11b is not limited to use with a colour wheel as the colour selector, but may be applied with other colour selectors. As an example, the rotating cylinder colour selector described by M. S. Brennesholtz et al, in ‘A single panel LCoS engine with a rotating drum and wide colour gamut’, SID Digest 2005, paper 64.3, could alternatively be used.

A light source system of the invention also compares favourably with the ‘sequential colour recapture’ (SCR) system described in the work of Dewald et al., in which light is re-circulated in the integrator rod. This is because, in the conventional SCR system, there is loss of light at the entrance aperture of the integrator rod, since light which is reflected back into the integrator rod and which is incident on the entrance aperture of the integrator rod will be lost. In a light source system of the present invention, light that is reflected back into the enclosure may be lost if it hits the light source 27 itself—however the dimensions of the light source 27 are typically much smaller than the area entrance aperture in the integrator rod of Dewald et al. which is required to be large enough to allow imaging an arc into the integrator rod, and the losses are therefore much smaller in a light source system of the present invention than in the ‘sequential colour recapture’ (SCR) system of Dewald et al.

FIG. 11c is a schematic block diagram of an image projection system incorporating the light source system and colour wheel of FIG. 11b. Collection optics, indicated generally at 5, image the light transmitted by the colour wheel onto a light modulator indicated generally at 6, which directs the light either through a projection lens 7 (for bright pixels) or onto a beam dump 8 (for dark pixels). A mirror 49 may be provided in the optical path to “fold” the optical path and thereby reduce the size of the image projection system.

The light source systems of the invention thus far described have a single light source 27. The invention is not however limited to a light source system having only a single light source, and a light source system of the invention may have more than one light source. In particular, a light source system of the invention may have a plurality of light sources arranged in an array.

The critical parameter for a light source in an image projection system is the “étendue”. Details of étendue calculations are given in the book Object displays, by Stupp and Brennesholtz (Wiley 1999). The étendue of a light source is proportional to the area of the light source and also to the solid angle subtended by the light emitted from the light source. Light from a light source with a large étendue cannot be usefully gathered into the optical system of a projector, and use of a light source with a large étendue thus leads to an inefficient projector system.

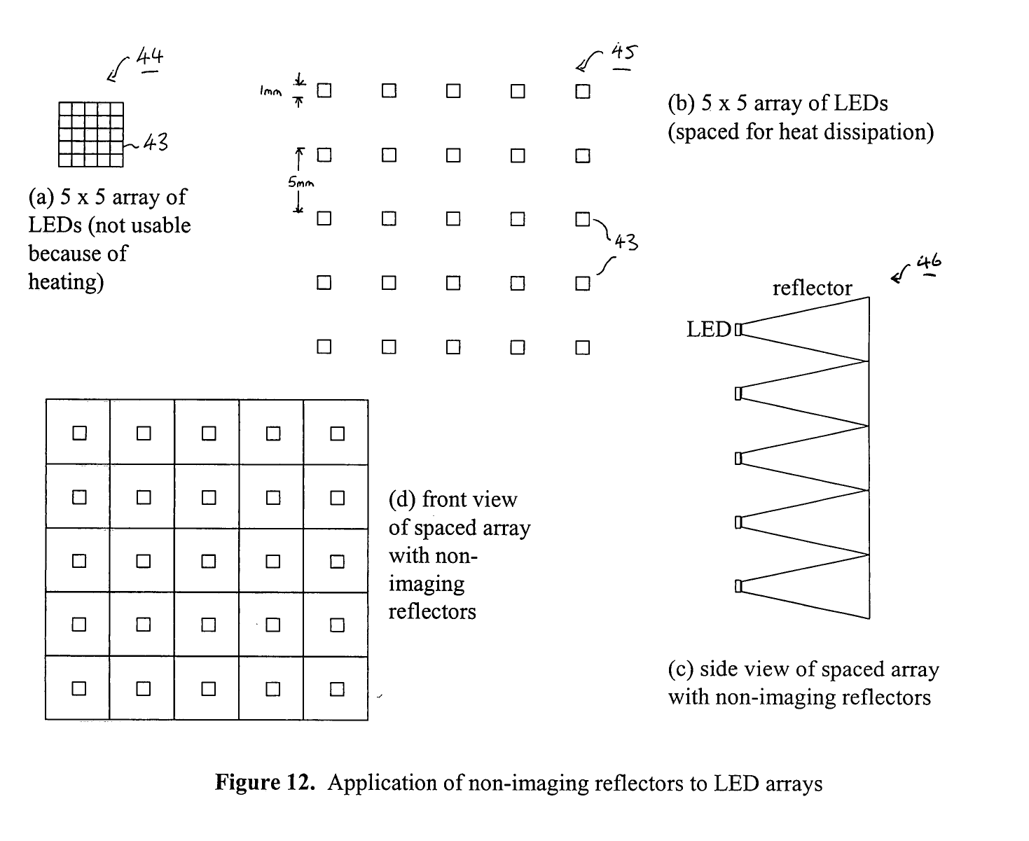

There is currently increasing use of light-emitting diodes (LEDs) as light sources, now that LEDs that emit white light are commercially available. However, the light output of a single LED is generally too low for an image projection system and many other applications, so that an array of many LEDs must be used. For example, a typical high-brightness LED chip 43 may produce 100 lm and be square in shape with an area of 1×1 mm². One might therefore suppose that an array of 5×5 LED chips could be constructed which would give a total light output of 2500 lm and have an area of 5×5 mm. Such an array 44 is shown in FIG. 12a. Conventional optics could then be used to image this light source onto a light modulator in a projector. Unfortunately, use of such an array is not possible because the heat generated by the LED chips must be dissipated. This forces the separation between adjacent LED chips to be increased, so that the pitch of the LED array might be 5 mm rather than 1 mm, leading to the array 45 shown in FIG. 12b. The array 45 of FIG. 12b has an area of 21×1 mm².

The étendue of a single LED 43 can be estimated by treating it as a Lambertian emitter with area A=1 mm². The étendue of such an emitter is πAn², where n is the refractive index of the material into which the LED emits light. The étendue of the 5×5 LED array 44 in FIG. 12a would be simply 25πAn². However, the étendue of the spaced LED array 45 in FIG. 12b would be 441πAn²−the total area of the array A_{T}=21²A has been used in this calculation, since using conventional optics to image the array 45 of FIG. 12b into a projection system would require imaging the whole area of the array. The étendue of the spaced LED array 45 of FIG. 12b is therefore greater than the étendue of the compact LED array 44 of FIG. 12a by a factor of more than 17. Thus, using the spaced array 45 as a light source in a projection system would be inefficient, since the large étendue of the array means that light from the array could not be coupled efficiently into the projection system.

FIGS. 12c and 12d are a front view and a side view respectively of a light source system 46 according to a further embodiment of the invention which overcomes the problem of the increase in étendue caused by the need to space the LEDs 43 apart to allow effective heat dissipation. In the light source system of this embodiment, each light source 43 of the spaced array 45 of FIG. 12 is mounted in its own non-imaging enclosure 28. The enclosures 28 themselves form an array, and are arranged preferably such that the output faces of the enclosures lie in a common plane, and preferably such that the output face of one enclosure is contiguous with the output face of each neighbouring enclosure. Each non-imaging enclosure 28 may be an enclosure as described above in any previous embodiment of the invention.

Each enclosure 28 of the light source system 46 is matched to a single LED 43, and performs the function as described above of taking light from a source with high divergence and small area and transforming it to a source with low divergence and a larger area. In this process, the étendue of the LED is conserved, or is almost conserved. Therefore, the étendue of the light field emerging from a single enclosure 28 of the light source system 46 is approximately equal to the étendue πAn² of a single-LED, and the overall étendue of the light source system 46 is approximately 25πAn²—this is the same as the étendue of the compact LED array 44 of FIG. 12a, and is much lower than the étendue of 441πAn² for the spaced LED array 45 of FIG. 12b. Hence, the étendue increase arising from the need to space the LEDs apart to allow dissipation of heat is eliminated. The lower étendue of the light source system 46 results in more efficient light gathering into a projection system and a brighter, more efficient projector.

In principle, each enclosure could contain two or more LEDs. However, to gain the full advantage of a reduced étendue, it would be necessary for the LEDs in each enclosure to be positioned very close to one another, and this could lead to difficulty in ensuring adequate dissipation of the heat generated by the LEDs in operation.

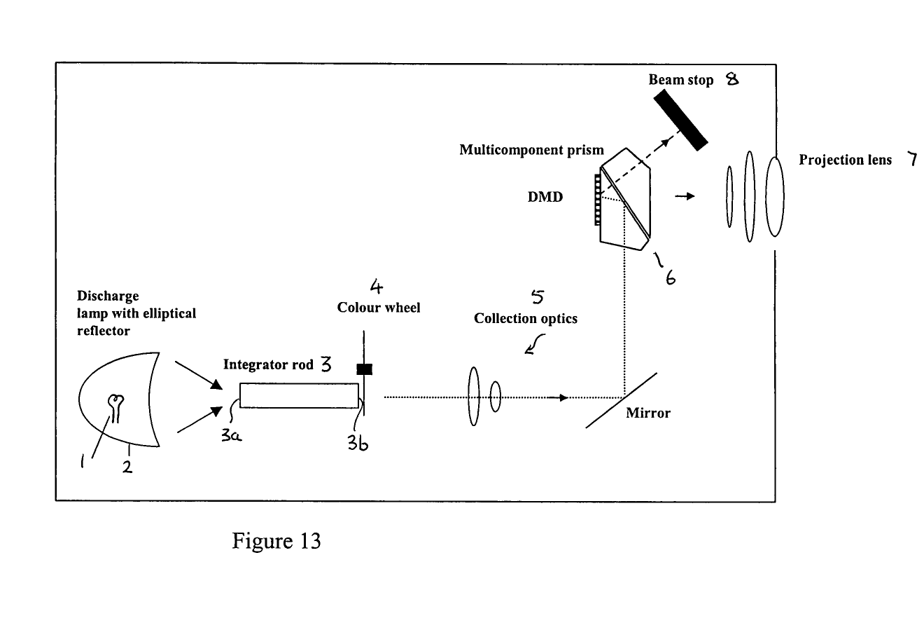

A light source system according to any embodiment of the invention may be incorporated in an image projection system, for example in an image projection system such as shown in FIG. 13. A light source system of the invention would replace the discharge lamp 1, the reflector 2 and the integrator rod 3 of the image projection system of FIG. 13.

Some other changes to the image projection system may also be necessary to account for the output characteristics of a light source system of the present invention. In particular, the output face of the enclosure of a light source system of the invention is larger than the output face of the integrator rod in an existing image projection system, while the range of ray angles (divergence) is smaller. The increase in area and the smaller divergence approximately cancel one another out, so that a conventional integrator rod and a light source system of the invention both have approximately the same étendue.

The differences between the integrator rod in an existing image projection system and a light source system of the invention requires two further changes in the image projection system. Firstly, the colour wheel 4 of FIG. 13 must be made larger if the image projection is modified to use a light source system of the present invention, so that the timing of the coloured segments of the colour wheel as they pass over the output face of the enclosure of the light source system is the same as the timing of the coloured segments as they pass over the output face of the integrator rod in system of FIG. 13. Secondly, the collection optics 5 must be adjusted so that they image the output face of the enclosure of the light source system onto the light modulator 6 with the correct magnification.

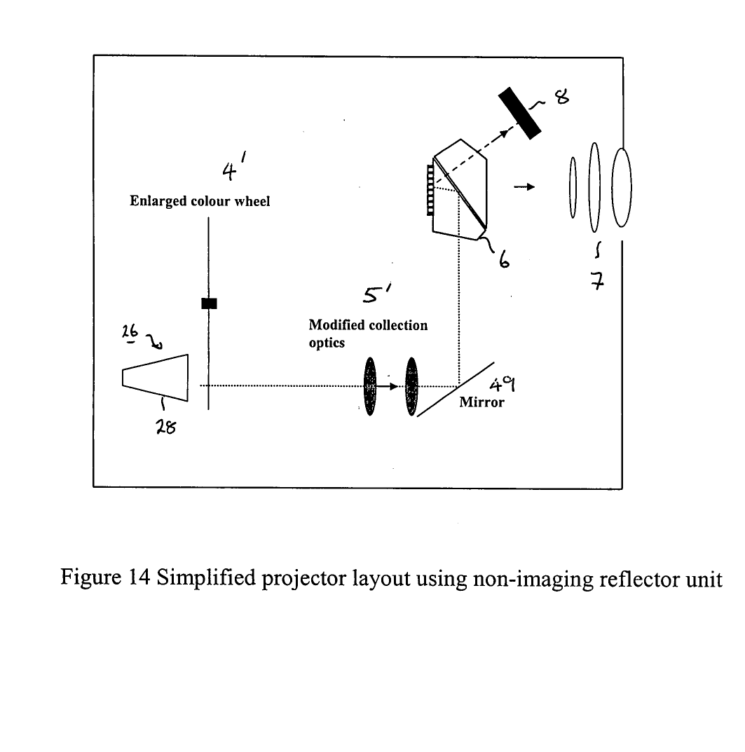

FIG. 14 is a schematic block diagram of an image projection system incorporating a light source system of the present invention. FIG. 14 shows a light source system 26 as described with reference to FIGS. 8a(i) to 8a(iv) above, but any light source system of the invention could be used in the image projection system of FIG. 14. FIG. 14 schematically indicates that the diameter of the colour wheel 4′ of the image projection system of FIG. 14 is greater than the diameter of the colour wheel 4 of the image projection system of FIG. 13. Also, the collection optics 5′ of the image projection system of FIG. 14 have been adjusted, compared to the collection optics 5 of the image projection system of FIG. 13, so that they image the output face of the enclosure 28 of the light source system 26 onto the light modulator 6 with the correct magnification. Mirror 49 “folds” the optical path, to reduce the physical size of the projection system.

This simple modification of a known image projection system shown in FIG. 14 will lead to a correctly functioning projector. However it may not be not the most effective way of taking advantage of the current invention. One disadvantage of the image projection system of FIG. 14 is that the enlarged colour wheel 4′ may increase the total size of the image projection system. This may partially remove the size reduction obtained by replacing the conventional lamp and integrator rod by a light source system of the invention.

One way of overcoming this disadvantage is to use a colour wheel in which the different colour regions of the wheel are separated by boundaries in the forms of spirals and which provides colour recycling, as described above and illustrated in FIG. 11a and 11b. FIG. 11c schematically shows an image projection system using this type of colour management. The advantage of this type of image projection system is that it provides a significant increase in brightness as a result of the colour recycling; however the constraints on timing of image switching on the light modulator are more severe than for a projection system using a simple colour wheel design.

A third type of image projection system that uses a light source system of the present invention uses a colour wheel which is not placed adjacent to the output face of the enclose, but is placed elsewhere in the optical system. The collection optics are designed so that, as the rays from the light source system pass through the plane of the colour wheel, the range of angles and the width of the beam are optimised to give good spectral performance from the colour wheel while maintaining the diameter of the colour wheel as small as possible.

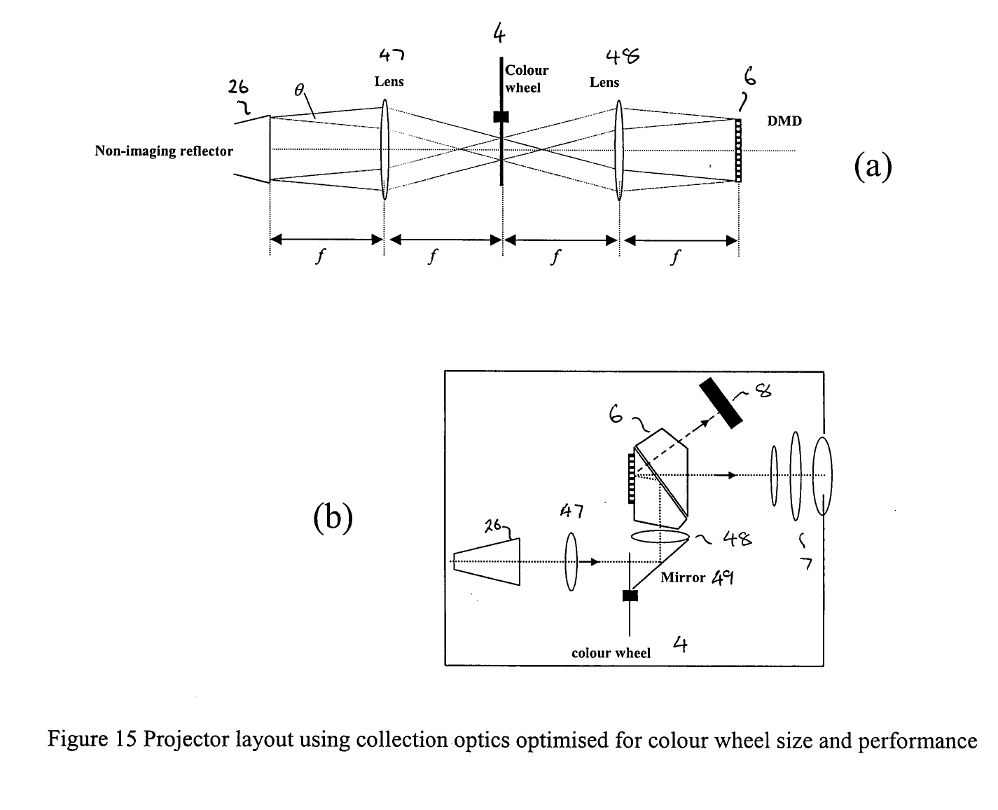

An example of such an optical system is shown in FIG. 15a. First and second lenses 47,48, with respective focal lengths f₁, f₂, are placed in image projection system, one on each side of a colour wheel 4. Each lens 47,48 is spaced from the colour wheel by a distance equal to its focal length. The first lens 47 is also spaced from the output face of the light source system 26 by a distance equal to its focal length f₁. Thus, the output face of the light source system 26 is at one focal plane of the first lens 47, while the colour wheel 4 is at the other focal plane of the first lens 47. The second lens 48 is placed so that its first focal plane coincides with the colour wheel 4, and so that its second focal plane coincides with the light modulator 6.

In this position, the first lens 47 effectively reverses the roles of angular divergence and beam width. If the beam emitted from the light source system 26 has width w and angular divergence θ, then the beam in the plane of the colour wheel has width θf₁ and angular divergence w/f₁. The focal length f₁ of the first lens 47 can therefore be adjusted to optimise the properties of the beam for the colour wheel. For example, if a coating can be placed on a colour wheel which provides desired transmission/reflection properties for a range of incident angles α, then it is possible to choose the focal length f₁ of the first lens 47 to match the angular divergence of light from the light source system 26 in the colour wheel plane to α by setting f₁=w/α.

The second lens 48 re-images the light passed by the colour wheel 4. Preferably the focal length f₂ of the second lens 48 is equal to the focal length f₁ of the first lens, so that the light field arriving at the light modulator 6 has the same characteristics as the light field at the exit face of the light source system 26. The light source system can therefore be designed to give the correct size and output angle range for the function of the light modulator.

In a commercial projector design, the optical system need not be extended linearly as in FIG. 15a, but may be folded using a mirror to save space. FIG. 15b schematically illustrates such an image projection system. A mirror 49 is placed in the light path from the light source system 26 to the SLM 6 to fold the optical path and thereby reduce the size of the image projection system. FIG. 15b shows a mirror 49 placed in the path of light from the colour wheel 4 to the spatial light modulator 6, but the mirror could alternatively be placed in the path of light from the light source system 26 to the colour wheel 4, for example between the first lens 47 and the colour wheel 4 or between the light source system 26 and the colour wheel 4.

The image projection systems of FIGS. 14, 15a and 15b have a colour wheel 4 as the wavelength selector. An image projection system of the invention is not however limited to this particular wavelength selector, and any suitable wavelength selector may be used.

1. A light source system comprising: a light source; and a non-imaging optical element, the non-imaging optical element having an output surface; wherein the light source is disposed within the non-imaging optical element.

2. A light source system as claimed in claim 1 wherein the non-imaging optical element has a first end and second end; wherein the second end of the non-imaging optical element is open and defines the output surface of the enclosure; and wherein the light source is disposed at or near the first end of the non-imaging optical element.

3. A light source system as claimed in claim 1 wherein the non-imaging optical element is closed at the first end.

4. A light source system as claimed in claim 1 wherein the non-imaging optical element is a reflective optical element.

5. A light source system as claimed in claim 1 wherein the non-imaging optical element has an angular light output range at the output surface that is lower than the angular light output range of the light source.

6. A light source system as claimed in claim 1 wherein the non-imaging optical element is a tapered light guide.

7. A light source system as claimed in claim 1 wherein the non-imaging optical element comprises a plurality of planar surfaces.

8. A light source system as claimed in claim 7 wherein a cross-section through the non-imaging optical element is substantially rectangular.

9. A light source system as claimed in claim 1 wherein a longitudinal section through the non-imaging optical element comprises a parabolic section.

10. A light source system as claimed in claim 1 wherein the non-imaging optical element is a compound parabolic concentrator.

11. A light source system as claimed in claim 1 wherein the non-imaging optical element has a first end, the longitudinal section of the first end being substantially a part of a circle; and wherein the light source is provided near the first end of the non-imaging optical element.

12. A light source system as claimed in claim 10 wherein the light source is positioned substantially at the centre of the part of the circle.

13. A light source system as claimed in claim 1 and further comprising a wavelength conversion material, the wavelength conversion material being provided within the non-imaging optical element.

14. A light source system as claimed in claim 12 wherein the wavelength conversion material converts radiation having a first wavelength into radiation having a second wavelength, the second wavelength being shorter than the first wavelength.

15. A light source system as claimed in claim 13 wherein the wavelength conversion material is provided near the first end of the non-imaging optical element.

16. A light source system as claimed in claim 13 and comprising a reflector provided in the non-imaging optical element in a path of light from the light source to the output face of the enclosure, the reflector reflecting, in use, light in at least a first wavelength range and transmitting light in at least a second wavelength range.

17. A light source system as claimed in claim 16 wherein the wavelength conversion material is provided in a path of light from the light source to the reflector.

18. A light source system as claimed in claim 16 wherein the reflector has a first surface; wherein the first surface of the reflector generally faces the light source; and wherein the wavelength conversion material is provided on the first surface of the reflector.

19. A light source system as claimed in claim 1 wherein the non-imaging optical element is provided with at least one edge reflector, the or each edge reflector being crossed with the longitudinal axis of the non-imaging optical element.

20. A light source system as claimed in claim 1 wherein the non-imaging optical element is so shaped that light entering the optical element at its output face is reflected within the optical element so as to be re-emitted from the output face of the optical element.

21. A light source system as claimed in claim 1 wherein the light source is a discharge light source.

22. A light source system as claimed in claim 21 wherein the light source is a high pressure discharge light source.

23. A light source system comprising: an array of at least first and second light sources; and at least first and second non-imaging optical elements, the first and second light sources being disposed within a respective one of the first and second non-imaging optical elements; wherein each of the first and second non-imaging optical elements has an output surface; and wherein the output surface of the first non-imaging optical element is substantially contiguous with the output surface of the second non-imaging optical element.

24. A light source system as claimed in claim 23 wherein the first non-imaging optical element has a first longitudinal axis; wherein the second non-imaging optical element has a second longitudinal axis; and wherein the first longitudinal axis is parallel to the second longitudinal axis.

25. A light source system as claimed in claim 23 wherein the output surface of the first non-imaging optical element and the output surface of the second non-imaging optical element lie in a common plane.

26. An image projection system comprising a light source system as claimed in claim 1.

27. An image projection system comprising a light source system as claimed in claim 23.

28. An image projection system as claimed in claim 26 and further comprising; a wavelength separator; and a spatial light modulator; wherein the wavelength separator is disposed within a path of light from the light source system to the spatial light modulator.

29. An image projection system as claimed in claim 28 and further comprising a first lens, the first lens being disposed within a path of light from the light source system to the wavelength separator.

30. An image projection system as claimed in claim 29 wherein the first lens has a first focal length; wherein the spacing between the output face of the light source system and the first lens is substantially equal to the first focal length; and wherein the spacing between the first lens and the wavelength separator is substantially equal to the first focal length.

31. An image projection system as claimed in claim 28 and further comprising a second lens, the second lens being disposed within a path of light from the wavelength separator to the spatial light modulator.

32. An image projection system as claimed in claim 31 wherein the second lens has a second focal length; wherein the spacing between the wavelength separator and the second lens is substantially equal to the second focal length; and wherein the spacing between the second lens and the spatial light modulator is substantially equal to the second focal length.

33. An image projection system as claimed in claim 32 wherein the second focal length is substantially equal to the first focal length.

34. An image projection system as claimed in claim 28 wherein the wavelength separator is a colour wheel.

35. An image projection system as claimed in claim 26 and further comprising; a wavelength separator; and a spatial light modulator; wherein the wavelength separator is disposed within a path of light from the light source system to the spatial light modulator.

36. An image projection system as claimed in claim 35 and further comprising a first lens, the first lens being disposed within a path of light from the light source system to the wavelength separator.

37. An image projection system as claimed in claim 36 wherein the first lens has a first focal length; wherein the spacing between the output face of the light source system and the first lens is substantially equal to the first focal length; and wherein the spacing between the first lens and the wavelength separator is substantially equal to the first focal length.

38. An image projection system as claimed in claim 35 and further comprising a second lens, the second lens being disposed within a path of light from the wavelength separator to the spatial light modulator.

39. An image projection system as claimed in claim 38 wherein the second lens has a second focal length; wherein the spacing between the wavelength separator and the second lens is substantially equal to the second focal length; and wherein the spacing between the second lens and the spatial light modulator is substantially equal to the second focal length.

40. An image projection system as claimed in claim 39 wherein the second focal length is substantially equal to the first focal length.

41. An image projection system as claimed in claim 35 wherein the wavelength separator is a colour wheel.
